(19) United States
(12) Patent Application Publication
(10) Pub. No.: US 2024/0055249 A1
(43) Pub. Date: Feb. 15, 2024

(54) ION SOURCE, MASS SPECTROMETER, AND CAPILLARY INSERTION METHOD

(71) Applicant: HITACHI HIGH-TECH CORPORATION, Minato-ku, Tokyo (JP)

(72) Inventors: Hideki HASEGAWA, Chiyoda-ku, Tokyo (JP); Masuyuki SUGIYAMA, Chiyoda-ku, Tokyo (JP)

(73) Assignee: HITACHI HIGH-TECH CORPORATION, Minato-ku, Tokyo (JP)

(21) Appl. No.: 18/257,941

(22) PCT Filed: Oct. 25, 2021
(86) PCT No.: PCT/JP2021/039197

§ 371 Date: Jun. 16, 2023

(30) Foreign Application Priority Data
Dec. 28, 2020 (JP) 2020-219072

(51) Int. Cl. H01J 49/16

(52) U.S. Cl. CPC H01J 49/167

(57) ABSTRACT

Provided is a technique for realizing high analysis reproducibility. An ion source of the present disclosure includes a capillary and a gas spray tube into which the capillary is inserted, the gas spray tube spraying a gas to an outer side of the capillary, and the gas spray tube having a deflection site, which deflects a downstream end of the capillary with respect to a central axis of a tip hole of the gas spray tube, on an upstream side of the tip hole of the gas spray tube.

### TECHNICAL FIELD

The present disclosure relates to an ion source, a mass spectrometer, and a capillary insertion method.

### BACKGROUND ART

One of general ionization methods used for mass spectrometry and the like is an electrospray method (hereinafter referred to as the “ESI method”). The ESI method is a method of introducing a sample solution from an upstream end of a capillary and spraying ions and droplets from a downstream end by an electric field or the like. In order to improve ionization efficiency, in some cases, a gas spray tube is concentrically arranged on the outer side of the capillary to spray a gas, or a heated gas is sprayed to the ions and droplets sprayed from the capillary.

Since an inner diameter of the capillary is extremely small, there is a high possibility that clogging occurs, and it is necessary to frequently replace the capillary depending on a type of the sample solution and use conditions. Since there is a gap between the outer surface of the capillary and the inner surface of the gas spray tube to allow the gas to flow, there is a possibility that a position of the capillary in the radial direction varies within a range of the gap when the capillary is replaced. Since a position of the downstream end of the capillary with respect to an ion introduction port of a mass spectrometer greatly depends on detection sensitivity, low assembly reproducibility causes degradation in reproducibility of the sensitivity.

PTL 1 discloses, as a technique for holding a capillary, a configuration in which “The guide 17 holds the capillary tube 4 in the through hole at the center part thereof such that the capillary tube 4 is placed coaxially with the inner injector tube 12 and the outer injector tube 11.” (see paragraph 0012 of PTL 1).

### CITATION LIST

### Patent Literature

PTL 1: JP 2006-038729 A

### SUMMARY OF INVENTION

### Technical Problem

In the structure described in PTL 1, the capillary tube 4 is held by the guide 17 concentrically with a small-inner-diameter portion of the inner injector tube 12 and a tip hole portion of the outer injector tube 11. However, when the capillary tube having an extremely small diameter is used, the capillary tube is easily bent on the downstream side of the guide 17, and a center position of a tip portion of the capillary tube is likely to be deviated from a central axis of the tip hole portion of the outer injector tube. Even if the center position of the tip portion of the capillary tube can be set at a position close to an ideal (concentric) position, there is a possibility that the tip portion of the capillary tube vibrates due to a gas flow when a gas is actually sprayed. As a matter of course, the position changes when the vibration occurs, which leads to variations in measurement results.

Therefore, the present disclosure provides a technique capable of realizing high analysis reproducibility.

### Solution to Problem

In order to solve the above problems, an ion source of the present disclosure includes a capillary, and a gas spray tube into which the capillary is inserted, the gas spray tube spraying a gas to the outer side of the capillary, and the gas spray tube has a deflection site, which deflects a downstream end of the capillary with respect to a central axis of a tip hole of the gas spray tube, on an upstream side of the tip hole of the gas spray tube.

Another characteristic relating to the present disclosure will become apparent from the description of the present specification and the accompanying drawings. Further, aspects of the present disclosure are achieved and realized by elements and combinations of various elements, and the following detailed description and aspects of the appended claims. The description in the present specification is merely illustrative and is not intended to limit the scope of the claims or the application of the present disclosure by no means.

### Advantageous Effects of Invention

According to the technique of the present disclosure, the reproducibility of positioning of the downstream end of the capillary is improved, and the high analysis reproducibility can be realized. Other objects, configurations, and effects which have not been described above become apparent from embodiments to be described hereinafter.

### BRIEF DESCRIPTION OF DRAWINGS

FIG. 1 is a schematic view illustrating a configuration of a mass spectrometer according to a first embodiment.

FIG. 2 is a cross-sectional view illustrating a structure of a part of an ion source according to the first embodiment.

FIG. 3 is a cross-sectional view for describing an effect of a deflection site.

FIG. 4 is a cross-sectional view illustrating a structure of a part of an ion source according to a second embodiment.

FIG. 5 is a cross-sectional view illustrating a structure of a part of an ion source according to a third embodiment.

FIG. 6 is a cross-sectional view illustrating a structure of a part of an ion source according to the fourth embodiment.

FIG. 7 is a cross-sectional view illustrating a structure of a part of an ion source according to a modification of the fourth embodiment.

FIG. 8 is a cross-sectional view illustrating a structure of a part of an ion source according to a fifth embodiment.

FIG. 9 is a cross-sectional view illustrating a structure of a part of an ion source according to a sixth embodiment.

FIG. 10 is a cross-sectional view illustrating a structure of a part of an ion source according to a seventh embodiment.

FIG. 11 is a cross-sectional view illustrating a structure of a part of an ion source according to an eighth embodiment.

FIG. 12 is a cross-sectional view illustrating a structure of a part of an ion source according to a ninth embodiment.

FIG. 13 is a cross-sectional view illustrating a structure of a part of an ion source according to a tenth embodiment.

FIG. 14 is a graph illustrating measurement results of the internal temperature of a first tube when gas flow rates are changed.

FIG. 15 is a cross-sectional view illustrating a structure of a part of a gas spray tube according to Comparative Example.

FIG. 16 is a photograph of a capillary inserted into a gas spray tube taken from the downstream side.

FIG. 17 is a graph obtained by plotting XY coordinates of centers of capillaries in Example and Comparative Example.

FIG. 18 is a graph illustrating a relationship between a high voltage applied to the capillary and relative ion intensity in Comparative Example.

FIG. 19 is a graph illustrating a relationship between a high voltage applied to the capillary and relative ion intensity in Example.

FIG. 20 is a cross-sectional view illustrating a part of a mass spectrometer used in an experiment for evaluating the dependence of a channel width.

FIG. 21 is a graph obtained by plotting CV values of a current under a condition that a distance L from a tip of the gas spray tube to the deflection site is 7 mm.

FIG. 22 is a graph obtained by plotting CV values of the current under a condition that the distance L from the tip of the gas spray tube to the deflection site is 9 mm.

FIG. 23 is a graph obtained by plotting CV values of the current under a condition that the distance L from the tip of the gas spray tube to the deflection site is 11 mm.

FIG. 24 is a view for describing a cause of a variation in a position of the capillary depending on a channel width W.

### DESCRIPTION OF EMBODIMENTS

### First Embodiment

### Configuration Example of Mass Spectrometer

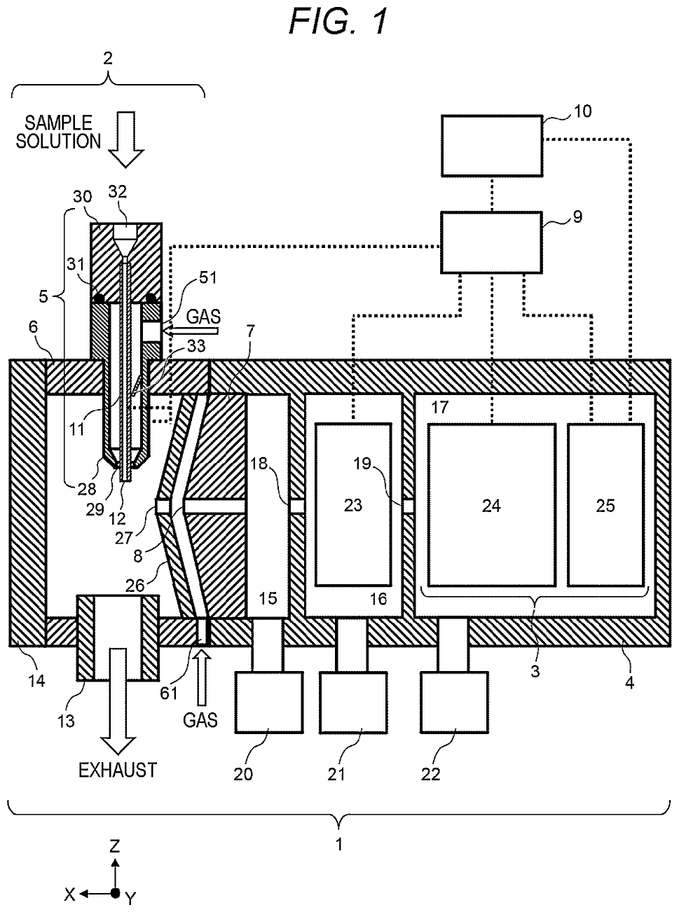

FIG. 1 is a schematic diagram illustrating a configuration of a mass spectrometer 1 according to a first embodiment. The mass spectrometer 1 includes an ion source 2, a mass spectrometry unit 3, a vacuum container 4, a power supply 9, a control device 10, vacuum pumps 20 to 22, and an ion transport unit 23. The mass spectrometry unit 3 and the ion transport unit 23 are provided in the vacuum container 4. In FIG. 1, cross-sections of the ion source 2 and the vacuum container 4 are illustrated.

The ion source 2 includes an ion generator 5 and an ion source chamber 6. The ion generator 5 includes a capillary 11, a gas spray tube 28, and a connector 30. A part of the gas spray tube 28 is inserted into the ion source chamber 6. One end portion of the capillary 11 is fixed to the connector 30 (fixing member) via a sealing means (not illustrated) such as a packing, an O-ring, and a ferrule, and the capillary 11 is inserted into the gas spray tube 28. In this manner, the gas spray tube 28 is disposed around the capillary 11. Note that the capillary 11 and the connector 30 may be integrated by adhesion, welding, brazing, or the like. A sealing member 31 for sealing of a gas is disposed between the gas spray tube 28 and the connector 30. In the example of FIG. 1, the sealing member is a face seal, but other configurations such as an axial seal may be used as long as airtightness can be maintained. As the sealing member 31, an O-ring, a packing, a ring made of resin or rubber, and the like can be used.

The gas spray tube 28 has a deflection site 33. The deflection site 33 comes into contact with the capillary 11 and deflects the capillary 11 with respect to the central axis of the gas spray tube 28. In the present disclosure, “deflection” means that the capillary 11 is shifted from the central axis of the gas spray tube 28. Details of a structure of the deflection site 33 will be described later.

The connector 30 has a connection portion 32 of a pipe (not illustrated), and the pipe is connected to the capillary 11 by connecting the pipe to the connection portion 32. When a sample solution is supplied to the pipe, the sample is supplied to the capillary 11. The power supply 9 is connected to the capillary 11 and the gas spray tube 28, and ions and droplets are sprayed from a downstream end 12 of the capillary 11 by an electric field or the like. The ions sprayed from the capillary 11 are introduced into the ion source chamber 6.

A value of a voltage applied to the capillary 11 by the power supply 9 can be, for example, about several kV (absolute value). Note that a voltage of +several kV is applied to the capillary 11 when generating positive ions. A voltage of −several kV is applied to the capillary 11 when generating negative ions. A flow rate of the sample solution depends on an inner diameter of the capillary 11, but is generally set in a range of nL/min to mL/min. Although depending on conditions such as a flow rate of the sample solution, both the inner diameter and an outer diameter of the capillary 11 can be set to, for example, about 1 mm or less.

The ion source chamber 6 is joined to the vacuum container 4, and ions are introduced from the ion source chamber 6 into the vacuum container 4. A sealed state (or a nearly sealed state) may be formed between the ion source chamber 6 and the vacuum container 4 such that droplets that are hardly introduced into the vacuum container 4, vaporized components thereof, and the like do not leak to the outside of the device. Furthermore, the ion source chamber 6 has an exhaust port 13 configured to exhaust such surplus components and the like. The ion source chamber 6 is a tubular member, and has one end portion covered by a window 14 and the other end portion provided with a counter electrode 26. The window 14 is made of a transparent member, such as glass, and a user can observe a spray state of the downstream end 12 of the capillary 11 through the window 14. A hole 27 is provided in a central portion of the counter electrode 26.

An opening of the vacuum container 4 is covered with an introduction electrode 7, and the introduction electrode 7 opposes the counter electrode 26 of the ion source chamber 6. A hole 8 is provided in a central portion of the introduction electrode 7. The interior of the vacuum container 4 is divided into three vacuum chambers 15, 16, and 17. The number of vacuum chambers is three in the example of FIG. 1, but may be more or less than three. A hole 18 and a hole 19 are provided in central portions of two partitions, respectively, that partition the vacuum chambers 15 to 17. The ion source chamber 6 and the vacuum chambers 15 to 17 communicate with each other through the hole 27 of the counter electrode 26, the hole 8 of the introduction electrode 7, and the hole 18 and the hole 19 of the partitions in the vacuum container 4. The holes 27, 8, 18, and 19 serve as ion passages. The counter electrode 26, the introduction electrode 7, and the partitions in the vacuum container 4 may be connected to the power supply 9 such that a voltage is applied thereto. In this case, these members to which the voltage is applied need to be insulated from a housing section, such as the vacuum container 4, using an insulator (not illustrated) or the like.

The vacuum chambers 15 to 17 are evacuated by the vacuum pump 20 to 22, respectively, and are typically held at about several hundred Pa, about several Pa, and about 0.1 Pa or less, respectively. The ion transport unit 23 is disposed in the vacuum chamber 16. The ion transport unit 23 may be disposed in the vacuum chamber 15 or 17. The mass spectrometry unit 3 is disposed in the vacuum chamber 17.

The power supply 9 is connected to the capillary 11, the gas spray tube 28, the ion transport unit 23, and the mass spectrometry unit 3 (an ion analyzer 24 and a detector 25), and applies a voltage thereto. The members to which the voltage is applied from the power supply 9 are attached to the vacuum container 4 or the ion source chamber 6 serving as a housing with an insulator (not illustrated) interposed therebetween.

The control device 10 is, for example, a computer terminal including a processor, a memory, an input/output device, and the like. The processor of the control device 10 executes a program stored in the memory, configured for control of the power supply 9 to control a timing of voltage application by the power supply 9 and a voltage value. The control device 10 receives an instruction input from the user and controls the power supply 9 and the like via the input/output device. Further, the control device 10 analyzes information such as mass and intensity of ions detected by the detector 25 in detail.

As the ion transport unit 23, a multi-pole electrode, an electrostatic lens, and the like can be used. The ion transport unit 23 causes ions to be transmitted while converging. A radio frequency voltage, a DC voltage, an AC voltage, a voltage combining these, and the like are applied to the ion transport unit 23 from the power supply 9. The ions generated by the ion source 2 are introduced into the vacuum container 4 through the hole 8 of the introduction electrode 7, introduced into the mass spectrometry unit 3 by the ion transport unit 23, and analyzed in the mass spectrometry unit 3.

The mass spectrometry unit 3 includes the ion analyzer 24 and the detector 25. The ion analyzer 24 separates and dissociates ions. As the ion analyzer 24, an ion trap, a quadrupole filter electrode, a collision cell, a time-of-flight mass spectrometer (TOF), a configuration combining these, and the like can be used. The ions that have passed through the ion analyzer 24 are detected by the detector 25. As the detector 25, an electron multiplier tube, a multi-channel plate (MCP), and the like can be used. The ions that have been detected by the detector 25 are converted into, for example, electrical signals and transmitted to the control device 10.

The power supply 9 applies various voltages to the mass spectrometry unit 3. As the voltages supplied from the power supply 9 to the mass spectrometry unit 3, a radio frequency voltage, a DC voltage, an AC voltage, a voltage combining these, and the like can be used.

The gas spray tube 28 is provided with a gas supply port 51, and a gas can be introduced between the capillary 11 and the gas spray tube 28. As a gas flows between the capillary 11 and the gas spray tube 28 and is sprayed from a tip hole 29 at a downstream end of the gas spray tube 28, vaporization of the droplets sprayed from the downstream end 12 of the capillary 11 can be promoted to improve ionization efficiency. A flow rate of the gas supplied to the gas spray tube 28 is, for example, about 0.5 to 10 L/min, and an inert gas, such as nitrogen or argon, can be used. An inner diameter of the tip hole 29 of the gas spray tube 28 can be set to, for example, about 1 mm or less.

In order to further improve the ionization efficiency, a method of heating a space into which the ions and droplets are sprayed from the downstream end 12 of the capillary 11 using a heated gas (about 800° C. at the maximum) may be used (not illustrated). A flow rate of the heated gas is, for example, about 0.5 to 50 L/min, and an inert gas, such as nitrogen or argon, can be used.

Further, the ion source chamber 6 is provided with a gas supply port 61 between the counter electrode 26 and the introduction electrode 7 of the vacuum container 4. As a gas flows between the introduction electrode 7 and the counter electrode 26 through the gas supply port 61 and is sprayed from the hole 27 of the counter electrode 26, noise components, such as excessive droplets sprayed from the downstream end 12 of the capillary 11 can be prevented from entering the hole 8 of the introduction electrode 7. A flow rate of the gas introduced between the introduction electrode 7 and the counter electrode 26 is, for example, about 0.5 to 10 L/min, and an inert gas, such as nitrogen or argon, can be used. A diameter of the hole 27 of the counter electrode 26 can be set to, for example, 1 mm or more, and the voltage applied to the counter electrode 26 can be set to, for example, about several ±kV at the maximum.

### Position Reproducibility of Capillary

When the capillary 11 is replaced due to clogging of the capillary 11 or the like, if a manufacturing error of a length of the capillary 11 is small, a position of the downstream end 12 in the Z direction (vertical direction on the paper surface of FIG. 1) is supposed to be reproduced. However, the inner diameter of the tip hole 29 of the general gas spray tube 28 is larger than the outer diameter of the capillary 11 in order to secure a gap serving as a gas channel, and thus, there is a possibility that a position of the capillary 11 having an extremely small diameter in the radial direction (XY direction) varies in this gap so that the position reproducibility through the replacement is degraded. Note that the Y direction is the depth direction of the paper surface of FIG. 1.

### Configuration Example of Gas Spray Tube

In order to overcome the above-described problem, the gas spray tube 28 of the ion source 2 according to the present embodiment is provided with the deflection site 33.

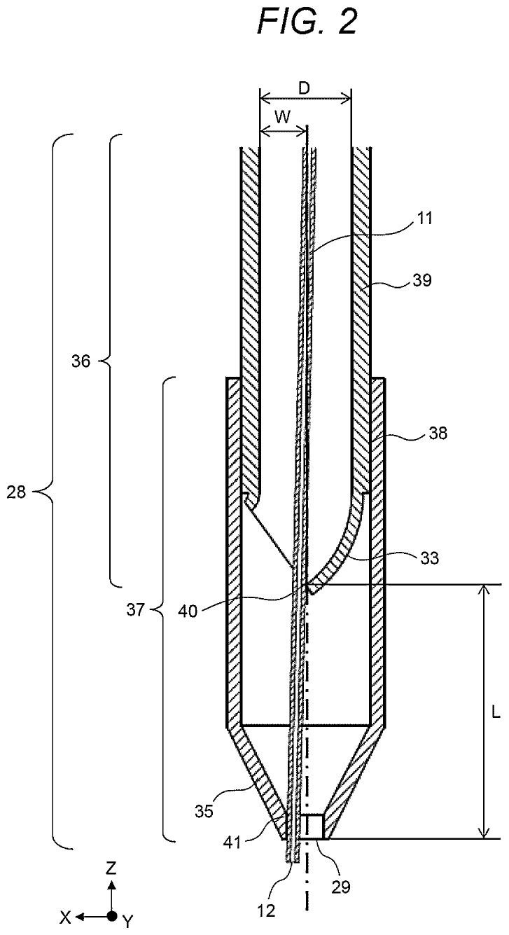

FIG. 2 is a cross-sectional view illustrating a structure of a part of the gas spray tube 28 according to the first embodiment. The gas spray tube 28 includes a first tube 36 on the upstream side and a second tube 37 on the downstream side. A part (fitting portion 38) of a cylindrical portion 39 of the first tube 36 is fitted into the second tube 37. The first tube 36 and the second tube 37 can be integrated by welding, press fitting, adhesion, pressure welding, a sealing member, a screw structure, and the like, and can have an airtight structure so as to prevent leakage of a gas and the like.

The deflection site 33 is provided at a tip portion of the first tube 36. The deflection site 33 has a bent structure, and can be formed, for example, by bending a tip portion of a tubular member (the first tube 36). The deflection site 33 is in contact with the capillary 11 at a contact point 40. As a result, the deflection site 33 deflects the downstream end 12 of the capillary 11 with respect to a central axis of the tip hole 29. For example, the deflection site 33 protrudes in the radial direction up to the vicinity of the central axis of the tip hole 29. In the example illustrated in FIG. 2, a tip of the deflection site 33 is on the central axis of the tip hole 29. Here, an inner diameter on the upstream side of the gas spray tube 28 is denoted by D, a channel width of the deflection site 33 is denoted by W, and a distance from a tip of the gas spray tube 28 to the deflection site 33 is denoted by L. The channel width W of the deflection site 33 is a distance between a straight line, which passes through the contact point 40 between the deflection site 33 and the capillary 11 and is parallel to an inner wall surface of the gas spray tube 28, and the inner wall surface of the gas spray tube 28. When the channel width W is set to about ½ of the inner diameter D (the deflection site 33 protrudes up to the vicinity of the central axis of the tip hole 29), it is possible to increase the reproducibility of the position of the downstream end 12 of the capillary 11. The reason thereof will be described later in the following experimental examples.

The second tube 37 is provided with a guide portion 35 between the tip hole 29 and the deflection site 33. The guide portion 35 has a tapered shape whose inner diameter decreases toward the downstream side. The guide portion 35 can be formed integrally with the second tube 37 by, for example, drawing. The tip hole 29 has a substantially constant inner diameter, and a cross-sectional shape of an inner wall surface thereof is linear. The tip hole 29 can also be formed integrally with the second tube 37 and the guide portion 35, for example, by drawing. Since such a shape is easy to manufacture, a manufacturing error hardly occurs. Note that the “tip hole 29” in the present specification means that not only an opening on a tip surface of the gas spray tube 28 but also a portion on the upstream side of the tip surface (the portion having a constant inner diameter in FIG. 2) may be included. However, the cross-sectional shape of the inner wall surface of the tip hole 29 is not necessarily linear, and may be rounded or tapered. The capillary 11 is in contact with the tip hole 29 at a contact point 41. The contact state between the capillary 11 and the tip hole 29 is not limited to point contact, and may be line contact or surface contact.

As illustrated in FIG. 2, the gas spray tube 28 provided with the deflection site 33 having the bent structure can be easily realized by being manufactured in a split structure including the upstream first tube 36 and the downstream second tube 37 (however, the split structure is not essential). In the case of the split structure, the manufacture can be easily performed by forming a structure in which the deflection site 33 is provided on the upstream first tube 36 and the downstream second tube 37 covers the outer side of the first tube 36 as illustrated in FIG. 2. Furthermore, with such a structure, it is also possible to secure a high channel conductance of a spray gas. Even if the deflection site 33 is provided by deforming the first tube 36 through molding by bending, the central axes of the cylindrical portion 39 of the upstream first tube 36 and the tip hole 29 can be aligned by securing the fitting portion 38.

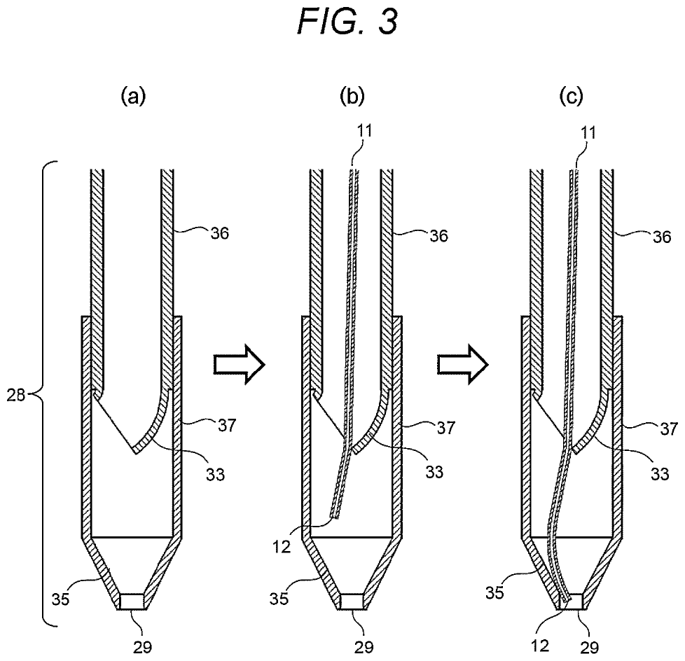

FIGS. 3(a) to 3(c) are cross-sectional views for describing an effect of the deflection site 33. FIG. 3(a) illustrates a state before the capillary 11 is inserted into the gas spray tube 28. FIGS. 3(b) and 3(c) illustrate a state in the middle of inserting the capillary 11. As illustrated in FIG. 3(b), when the capillary 11 is inserted from above the gas spray tube 28, the downstream end 12 is deflected with respect to the central axis of the tip hole 29 by the deflection site 33. As illustrated in FIG. 3(c), when the capillary 11 is further inserted to the downstream side, the downstream end 12 of the capillary 11 is returned to the inner side along the guide portion 35. When the capillary 11 is further inserted and the downstream end 12 of the capillary 11 reaches a position of slightly sticking out from the tip hole 29 of the gas spray tube 28, the capillary 11 tries to return to a straight shape by an elastic force, and thus, is locked by two points of the contact point 40 between the capillary 11 and the deflection site 33 and the contact point 41 between the capillary 11 and the tip hole 29 (state of FIG. 2). As a result, the position of the capillary 11 in the radial direction can be set with good reproducibility.

Although it has been described above that the ion source 2 of the present embodiment is mounted on the mass spectrometer 1, the ion source 2 can also be mounted on a detection means (device) other than the mass spectrometer 1. The same applies to each embodiment to be described hereinafter. In the ion source 2 of the present disclosure, the capillary 11 deflected by the deflection site 33 is brought to one side of the tip hole 29 of the gas spray tube 28. When an introduction electrode of the detection means, such as the mass spectrometer 1, is disposed on an extension line of an axis in a deflection direction of the capillary 11, ion introduction efficiency can be improved. However, the deflection direction of the capillary 11 may be a direction toward the introduction electrode of the detection means or a direction toward the opposite side. When the capillary 11 is directed to the introduction electrode, electric field strength increases, so that sensitivity can be prioritized. On the other hand, when the capillary 11 is directed to the opposite side of the introduction electrode, a larger amount of gas flows between the capillary 11 and the introduction electrode, so that reduction of noise inflow due to the gas can be prioritized.

### Summary of First Embodiment

As described above, the ion source 2 according to the first embodiment includes the capillary 11 into which the sample solution is introduced and the gas spray tube 28 disposed on the outer side of the capillary 11, and the gas spray tube 28 has the deflection site 33, which deflects the downstream end 12 of the capillary 11 with respect to the central axis of the tip hole 29 of the gas spray tube 28, on the upstream side of the tip hole 29 of the gas spray tube 28. When the capillary 11 is set in the ion source 2, the capillary 11 is inserted into the gas spray tube 28 such that the capillary 11 comes into contact with the deflection site 33 and the tip hole 29 of the gas spray tube 28. With such a configuration, the reproducibility of the radial position of the downstream end 12 of the capillary 11 is improved. As a result, the ion source with high analytical stability can be realized.

### Second Embodiment

In the first embodiment, the ion source in which the deflection site 33 provided in the gas spray tube 28 is configured by the bent structure has been described. In a second embodiment, a deflection site configured by an eccentric structure is proposed as another structure of the deflection site. Note that only differences from the first embodiment will be described in each of the following embodiments.

### Configuration Example of Gas Spray Tube

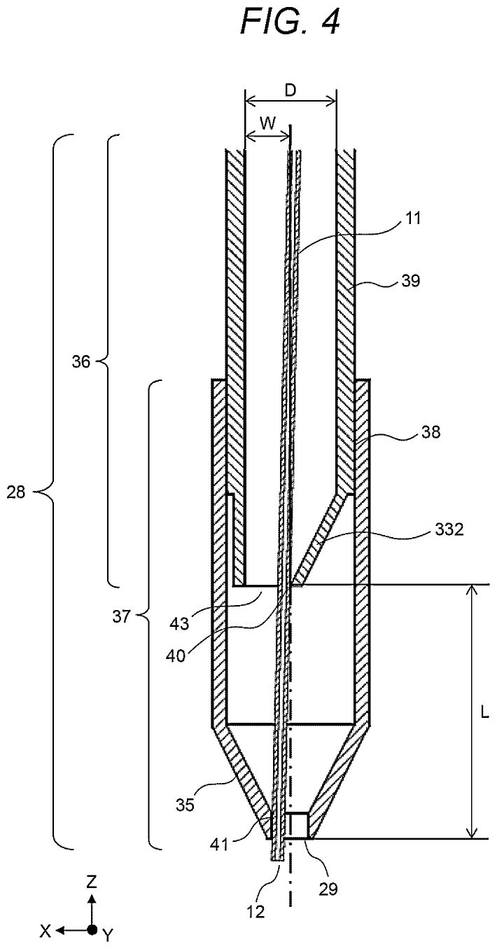

FIG. 4 is a cross-sectional view illustrating a structure of a part of the gas spray tube 28 according to the second embodiment. Members having the same configurations as those of the first embodiment are denoted by the same reference signs. As illustrated in FIG. 4, the gas spray tube 28 according to the present embodiment has a deflection site 332 having an eccentric structure. The deflection site 332 is provided at a tip portion of the first tube 36. The deflection site 332 has an opening 43 eccentric with respect to the central axis of the tip hole 29 of the gas spray tube 28. That is, the opening 43 is also eccentric with respect to the central axis of the cylindrical portion 39 of the first tube 36. The deflection site 332 is in contact with the capillary 11 at the contact point 40 on the opening 43 and deflects the downstream end 12 of the capillary 11 with respect to the central axis of the tip hole 29 of the gas spray tube 28.

The deflection site 332 can be formed, for example, by drawing a part of a tip portion of a tubular member (the first tube 36). The deflection site 332 may be formed by rolling, or may be formed by being welded to the tip of the cylindrical portion 39 of the first tube 36.

### Summary of Second Embodiment

As described above, in the ion source 2 according to the second embodiment, the gas spray tube 28 is provided with the deflection site 332 having the eccentric structure, and the deflection site 332 deflects the downstream end 12 of the capillary 11 with respect to the central axis of the tip hole 29 of the gas spray tube 28. When the capillary 11 is inserted, the capillary 11 is locked by two points of the contact point 40 between the capillary 11 and the deflection site 332 and the contact point 41 between the capillary 11 and the tip hole 29 inside the gas spray tube 28. Such a configuration also enables achievement of the same effect as that of the first embodiment.

### Third Embodiment

In a third embodiment, a deflection site configured using a plate-shaped member is proposed as another structure of the deflection site of the gas spray tube.

### Configuration Example of Gas Spray Tube

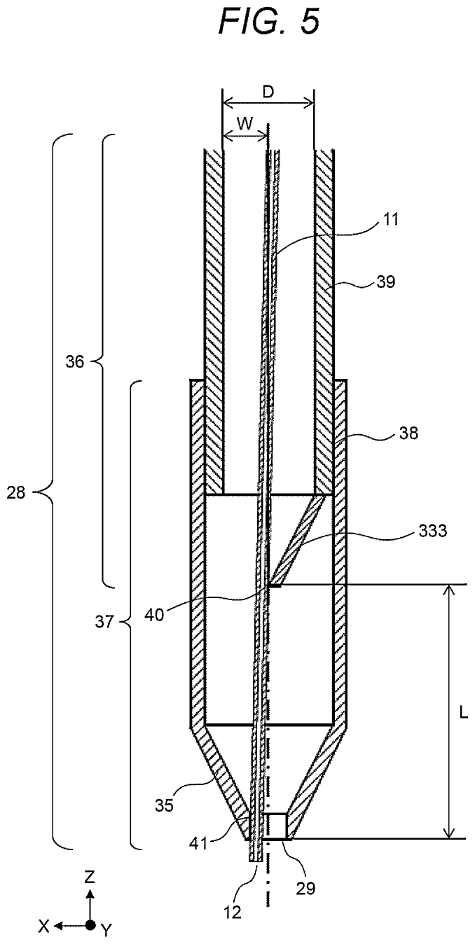

FIG. 5 is a cross-sectional view illustrating a structure of a part of the gas spray tube 28 according to the third embodiment. As illustrated in FIG. 5, the gas spray tube 28 according to the present embodiment has a deflection site 333 formed using a plate-shaped member (baffle plate). The deflection site 333 is in contact with the capillary 11 at the contact point 40 and deflects the downstream end 12 of the capillary 11 with respect to the central axis of the tip hole 29 of the gas spray tube 28. The deflection site 333 is provided at a part of a tip portion of the first tube 36. The deflection site 333 may be curved similarly to curvature of an inner surface of the first tube 36 or may be flat. The structure of the deflection site 333 is not limited to the plate shape as illustrated in FIG. 5, and is not limited thereto as long as the same effect as that of the above-described embodiment can be achieved.

The deflection site 333 can be formed, for example, by fixing the plate-shaped member to a tip of the cylindrical portion 39 by welding, bonding, or other joining methods.

### Summary of Third Embodiment

As described above, in the ion source 2 according to the third embodiment, the gas spray tube 28 is provided with the deflection site 333 having the plate shape, and the deflection site 333 deflects the downstream end 12 of the capillary 11 with respect to the central axis of the tip hole 29 of the gas spray tube 28. Such a configuration also enables achievement of the same effect as that of the first embodiment.

### Fourth Embodiment

In a fourth embodiment, as another structure of the deflection site of the gas spray tube, a deflection site having a protruding shape that protrudes in the radial direction from an inner wall surface of the gas spray tube is proposed.

### Configuration Example of Gas Spray Tube

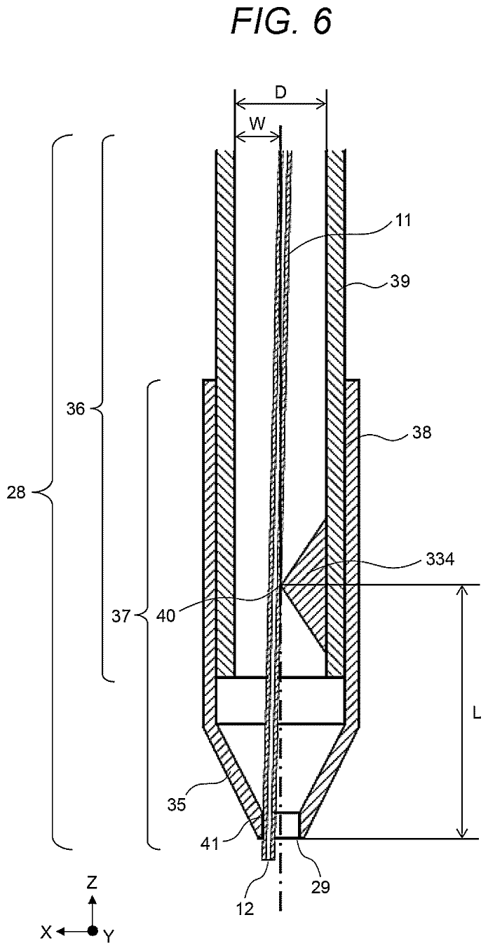

FIG. 6 is a cross-sectional view illustrating a structure of a part of the gas spray tube 28 according to the fourth embodiment. As illustrated in FIG. 6, the gas spray tube 28 according to the present embodiment has a deflection site 334 formed using a protrusion protruding radially inward from an inner wall surface of the first tube 36. The deflection site 334 is in contact with the capillary 11 at the contact point 40 and deflects the downstream end 12 of the capillary 11 with respect to the central axis of the tip hole 29 of the gas spray tube 28.

Although a cross-sectional shape of the deflection site 334 illustrated in FIG. 6 is a triangle, the deflection site 334 can have any shape, such as a conical shape, a pyramidal shape, or a triangular prism shape, and a bottom surface (surface in contact with the inner wall surface of the first tube 36) thereof can be curved in accordance with curvature of the inner wall surface. Further, a top portion (the most radially inner portion) of the deflection site 334 may be rounded. Furthermore, the cross-sectional shape of the deflection site 334 is not limited to the triangle, and may be any shape such as a quadrangle or a semicircle.

The deflection site 334 can be formed by fixing a member to the inner wall surface of the gas spray tube 28 by welding, bonding, or other bonding methods. Alternatively, the gas spray tube 28 may be crushed and deformed from the outside to form the protrusion, thereby forming the deflection site 334.

### Modification of Fourth Embodiment

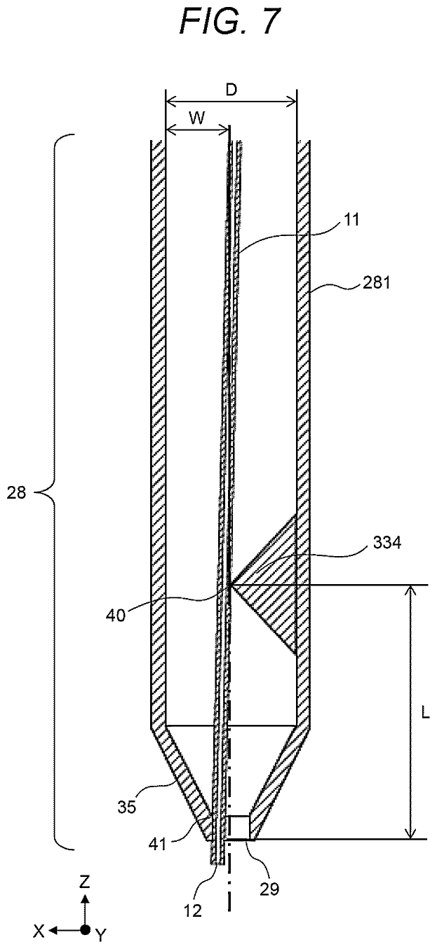

FIG. 7 is a cross-sectional view illustrating a structure of a part of the gas spray tube 28 according to a modification of the fourth embodiment. As illustrated in FIG. 7, the gas spray tube 28 according to the present embodiment includes a single tube 281, and has the deflection site 334 formed using a protrusion protruding radially inward from an inner wall surface of the tube 281. In this manner, even when the gas spray tube 28 has a single structure, the deflection site 334 is in contact with the capillary 11 at the contact point 40 and deflects the downstream end 12 of the capillary 11 with respect to the central axis of the tip hole 29 of the gas spray tube 28.

### Summary of Fourth Embodiment

As described above, the ion source 2 according to the fourth embodiment has the deflection site 334 protruding from the inner wall surface of the gas spray tube 28, and the deflection site 334 deflects the downstream end 12 of the capillary 11 with respect to the central axis of the tip hole 29 of the gas spray tube 28. Such a configuration also enables achievement of the same effect as that of the first embodiment.

### Fifth Embodiment

In a fifth embodiment, another structure of the guide portion of the gas spray tube 28 is proposed.

### Configuration Example of Gas Spray Tube

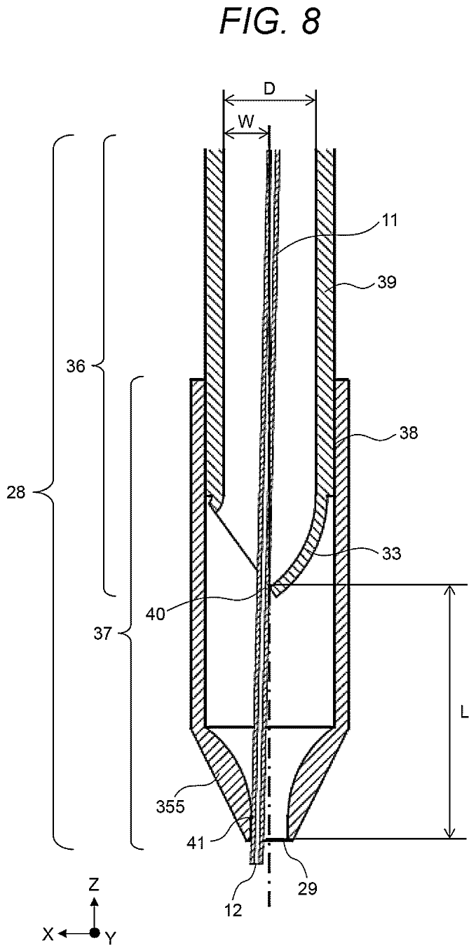

FIG. 8 is a cross-sectional view illustrating a structure of a part of the gas spray tube 28 according to the fifth embodiment. As illustrated in FIG. 8, a guide portion 355 of the gas spray tube 28 according to the present embodiment has a shape whose inner diameter continuously decreases such that a change rate of the inner diameter decreases toward the downstream side. The inner diameter of the guide portion 355 is constant in the vicinity of the tip hole 29. The guide portion 355 having such a shape can be formed by, for example, drilling. Even when the guide portion 355 has the shape as illustrated in FIG. 8, the capillary 11 is in contact with the deflection site 33 at the contact point 40, and is in contact with the tip hole 29 of the guide portion 35 at the contact point 41. The above configuration of the fifth embodiment also enables achievement of the same effect as that of the first embodiment.

### Sixth Embodiment

In a sixth embodiment, another structure of the guide portion of the gas spray tube 28 will be described.

### Configuration Example of Gas Spray Tube

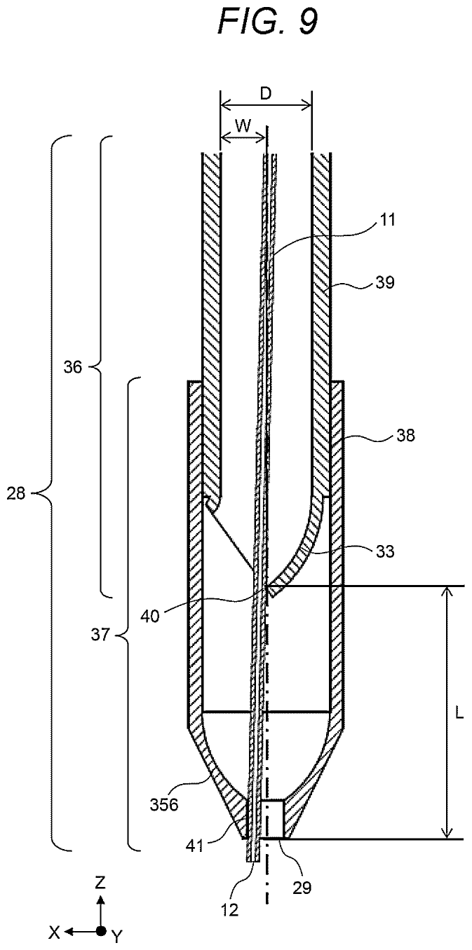

FIG. 9 is a cross-sectional view illustrating a structure of a part of the gas spray tube 28 according to the sixth embodiment. As illustrated in FIG. 9, a guide portion 356 of the gas spray tube 28 according to the present embodiment has a shape whose inner diameter continuously decreases such that a change rate of the inner diameter increases toward the downstream side. The inner diameter of the guide portion 356 is constant in the vicinity of the tip hole 29. The guide portion 356 having such a shape can be formed by, for example, drilling. Note that the shape of the guide portion is not limited to the structure of the sixth embodiment or the seventh embodiment, and it is sufficient that a shape whose inner diameter continuously decreases toward the downstream side is provided. The above configuration of the sixth embodiment also enables achievement of the same effect as that of the first embodiment.

### Seventh Embodiment

In a seventh embodiment, another structure of the guide portion of the gas spray tube 28 is proposed.

### Configuration Example of Gas Spray Tube

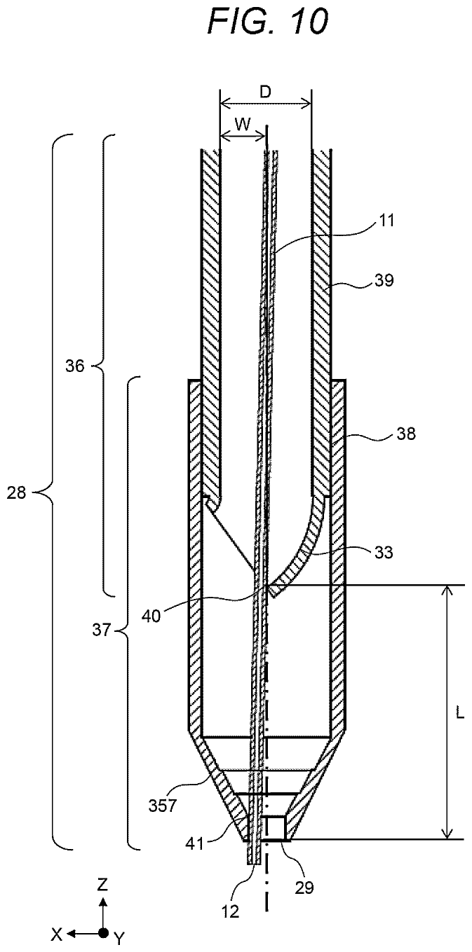

FIG. 10 is a cross-sectional view illustrating a structure of a part of the gas spray tube 28 according to the seventh embodiment. As illustrated in FIG. 10, a guide portion 357 of the gas spray tube 28 according to the present embodiment has a shape whose inner diameter continuously decreases toward the downstream side, and has an inner wall surface formed in a stepped shape. The inner diameter of the guide portion 357 is constant in the vicinity of the tip hole 29. The guide portion 357 having such a shape can be formed by, for example, drilling. Note that the shape of the guide portion may be a tapered shape, another continuous shape, a stepped shape, or a combination thereof. The above configuration of the seventh embodiment also enables achievement of the same effect as that of the first embodiment.

### Eighth Embodiment

In an eighth embodiment, another structure of the tip hole of the gas spray tube 28 is proposed.

### Configuration Example of Gas Spray Tube

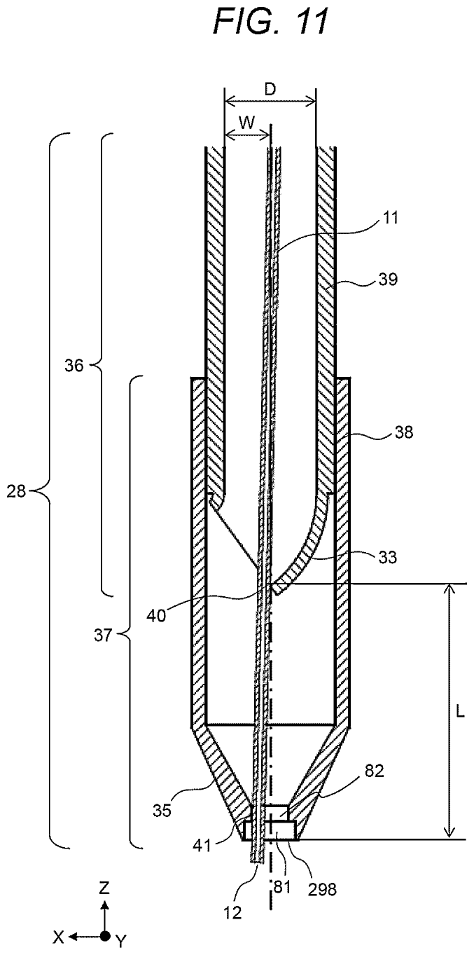

FIG. 11 is a cross-sectional view illustrating a structure of a part of the gas spray tube 28 according to the eighth embodiment. As illustrated in FIG. 11, a tip hole 298 of the gas spray tube 28 according to the present embodiment includes a first portion 81 and a second portion 82 having different inner diameters. The inner diameter of the first portion 81 on the downstream side is larger than the inner diameter of the second portion 82 on the upstream side. Note that the tip hole of the gas spray tube 28 may include three or more (a plurality of) portions having different inner diameters, and is formed such that the inner diameter becomes larger toward the downstream side among the plurality of portions. Such a shape can be formed by counterboring, for example.

In the configuration of the present embodiment, the capillary 11 is in contact with the second portion 82 on the upstream side at the contact point 41. An effect of such a configuration will be described. The capillary 11 is exposed to a high voltage and a high temperature, and there is also a possibility that the downstream end 12 of the capillary 11 is severely deteriorated depending on components of samples (containing acid, alkali, and the like in some cases). There is also a possibility that corrosion is accelerated when a corrosive sample is accumulated in a portion of the downstream end 12 of the capillary 11. Thus, it is possible to prevent the sample from accumulating in the vicinity of the downstream end 12 of the capillary 11 by setting a state in which a gas is appropriately sprayed. When the first portion 81 having a larger diameter is not provided, the capillary 11 is in contact with an inner wall surface of the tip hole 29, and thus, the gas hardly flows due to a phase of contact portion. Therefore, when a large-diameter portion (the first portion 81) is provided on the downstream end side of the gas spray tube 28 as in the present embodiment, there is an effect of facilitating the flow of the gas.

### Summary of Eighth Embodiment

As described above, in the ion source 2 according to the eighth embodiment, the tip hole of the gas spray tube 28 includes the plurality of portions having different inner diameters, and the inner diameter on the downstream side of the tip hole is larger than that on the upstream side. With such a configuration, the gas can easily flow at the downstream end of the gas spray tube 28, and the corrosion of the capillary 11 and the gas spray tube 28 due to the sample can be prevented. Therefore, the ion source with high durability can be realized.

### Ninth Embodiment

In the first to eighth embodiments, the configuration in which the gas spray tube 28 has one deflection site has been described. A ninth embodiment proposes a configuration in which a plurality of deflection sites of the gas spray tube 28 are provided.

### Configuration Example of Gas Spray Tube

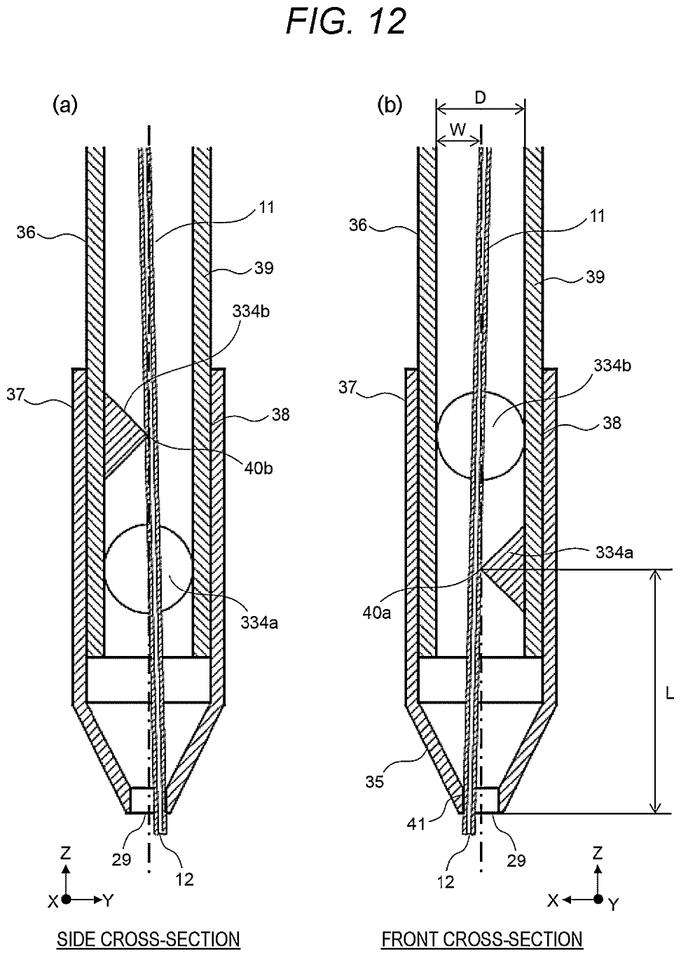

FIGS. 12(a) and 12(b) are cross-sectional views illustrating a structure of a portion of the gas spray tube 28 according to the ninth embodiment. FIG. 12(a) illustrates a side cross-sectional view of the gas spray tube 28. FIG. 12(b) is a front cross-sectional view of the gas spray tube 28. As illustrated in FIGS. 12(a) and 12(b), the gas spray tube 28 according to the present embodiment is provided with two deflection sites 334a and 334b at different positions in the longitudinal direction of the gas spray tube 28 and at different phases. The deflection site 334a is disposed on the downstream side and protrudes in the X direction. The deflection site 334b is disposed on the upstream side and protrudes in the Y direction. The capillary 11 is in contact with the deflection site 334b at a contact point 40b, in contact with the deflection site 334a at a contact point 40a, and in contact with the tip hole 29 at the contact point 41. Therefore, the capillary 11 is locked at three points inside the gas spray tube 28. Since the plurality of deflection sites at different positions in the longitudinal direction of the gas spray tube 28 and at different phases are provided in this manner, it is possible to regulate a direction in which the capillary 11 escapes even when a deflection function is insufficient with one deflection site, and thus, the reproducibility of the position of the capillary 11 is improved.

### Summary of Ninth Embodiment

As described above, the ion source 2 according to the ninth embodiment has the plurality of deflection sites 334a and 334b protruding from the inner wall surface of the gas spray tube 28, and the deflection sites 334a and 334b are provided at different positions in the longitudinal direction of the gas spray tube 28 and at different phases. The deflection sites 334a and 334b deflect the downstream end 12 of the capillary 11 with respect to the central axis of the tip hole 29 of the gas spray tube 28. With such a configuration, the reproducibility of the radial position of the downstream end 12 of the capillary 11 is further improved. As a result, the ion source with higher analytical stability can be realized.

### Tenth Embodiment

In the first to ninth embodiments, the gas spray tube 28 having the configuration in which the upstream first tube 36 and the downstream second tube 37 are fitted has been described. In a tenth embodiment, the gas spray tube 28 having a configuration in which a radial space is provided between a first tube and a second tube is proposed.

### Configuration Example of Gas Spray Tube

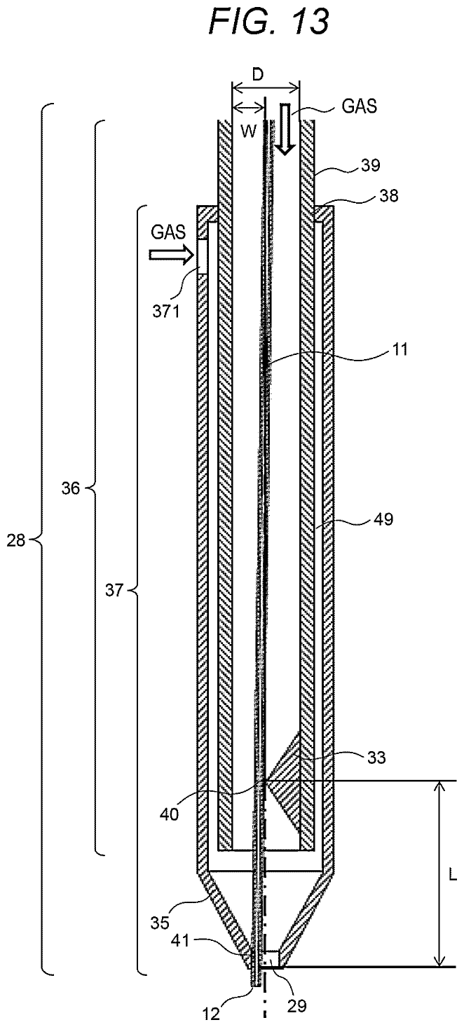

FIG. 13 is a cross-sectional view illustrating a structure of a part of the gas spray tube 28 according to the tenth embodiment. As illustrated in FIG. 13, in the gas spray tube 28 according to the present embodiment, the first tube 36 is inserted into the second tube 37, and a space 49 is provided between an outer surface of the first tube 36 and an inner surface of the second tube 37. The second tube 37 is provided with a gas supply port 371. Although not illustrated in FIG. 13, the first tube 36 is also provided with a gas supply port (the gas supply port 51 illustrated in FIG. 1). A deflection site of the present embodiment is the deflection site 334 of the fourth embodiment, but the deflection sites having the configurations of the other embodiments may be used.

A heating unit configured to cause a heated gas to flow is often employed around the capillary 11 or the gas spray tube 28 in order to improve ionization efficiency (not illustrated). Therefore, it is desirable to insulate heat transferred from the heating unit to the capillary 11 as much as possible. Since the gas spray tube 28 has a double structure in the present embodiment, a high heat insulation effect can be realized.

### Experiment for Confirmation of Heat Insulation Effect

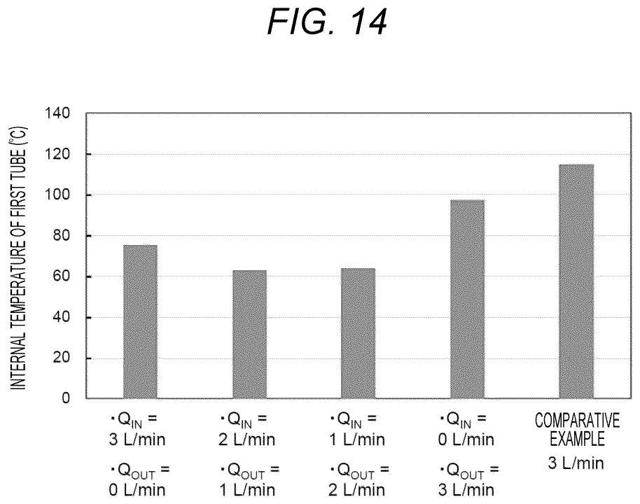

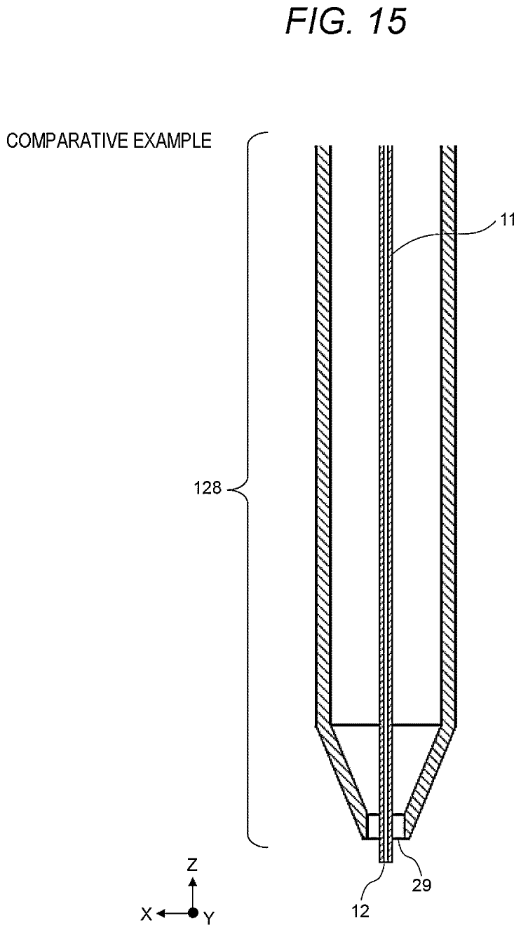

In order to confirm the heat insulation effect, an experiment was conducted in which a gas was supplied to the gas spray tube 28 having the configuration of the present embodiment to measure the internal temperature of the first tube 36. Specific conditions are as follows. A straight portion of the first tube 36 was formed to have an outer diameter of 2 mm and an inner diameter of 1.4 mm. A straight portion of the second tube 37 was formed to have an outer diameter of 3 mm and an inner diameter of 2.6 mm. The temperature of a heated gas from the heating unit was 500° C., a flow rate of the heated gas was 15 L/min, and a type of the heated gas was nitrogen. The internal temperature of the first tube 36 was measured by changing a gas flow rate (Q_{IN}) of a gas flowing into the first tube 36 and a gas flow rate (Q_{OUT}) of a gas flowing into the space 49. The temperature was measured by inserting a K-type (chromel-alumel) sheathed thermocouple having an outer diameter of 0.5 mm into the first tube 36. The gas flow rates Q_{IN} and Q_{OUT} were set to a combination of 0 L/min and 3 L/min and a combination of 1 L/min and 2 L/min so as to be 3 L/min in total. Further, a gas was also supplied to a gas spray tube having a single structure in which no deflection site is not provided (a gas spray tube 128 according to Comparative Example illustrated in FIG. 15) at a flow rate of 3 L/min, and the internal temperature of the gas spray tube 128 was measured. Results thereof are illustrated in FIG. 14.

FIG. 14 is a graph illustrating measurement results of the internal temperature of the first tube 36 when the gas flow rates Q_{IN} and Q_{OUT} are changed. As illustrated in FIG. 14, it can be seen that the internal temperature of the first tube 36 is lower in the configuration of the present embodiment than that in Comparative Example. Since the internal temperature of the first tube 36 is low, the temperature of the capillary 11 can also be maintained low, so boiling of a sample solution can be prevented. As a result, stability of analysis can be improved. Note that the gas may be caused to flow through both the first tube 36 and the second tube 37 as in the present experiment, or may be caused to flow through either one of them.

### Summary of Tenth Embodiment

As described above, in the ion source 2 according to the tenth embodiment, the gas spray tube 28 includes the first tube 36 and the second tube 37, and the space 49 is provided between the first tube 36 and the second tube 37. With such a configuration, an increase in the internal temperature of the capillary 11 inserted into the first tube 36 can be suppressed, and thus, the stability of analysis can be improved, and the ion source with higher reproducibility can be realized.

### Experimental Examples

Effects of a technique of the present disclosure will be described by the following experimental examples.

### Preparation of Gas Spray Tube

First, a gas spray tube (Example) having the configuration illustrated in the fourth embodiment (FIG. 6) and a gas spray tube (Comparative Example) having no deflection site were actually manufactured. As described above, the gas spray tube 28 of the fourth embodiment has the deflection site 334 formed in the protruding shape.

FIG. 15 is a cross-sectional view illustrating a structure of a part of the gas spray tube 128 according to Comparative Example. The gas spray tube 128 includes a single tube and has no deflection site. Diameters of the tip hole 29 of each of the gas spray tube 28 of Example and the gas spray tube 128 of Comparative Example were all set to 0.4 mm. An outer diameter of the capillary 11 was set to 0.27 mm.

### Regarding Reproducibility of Capillary Position

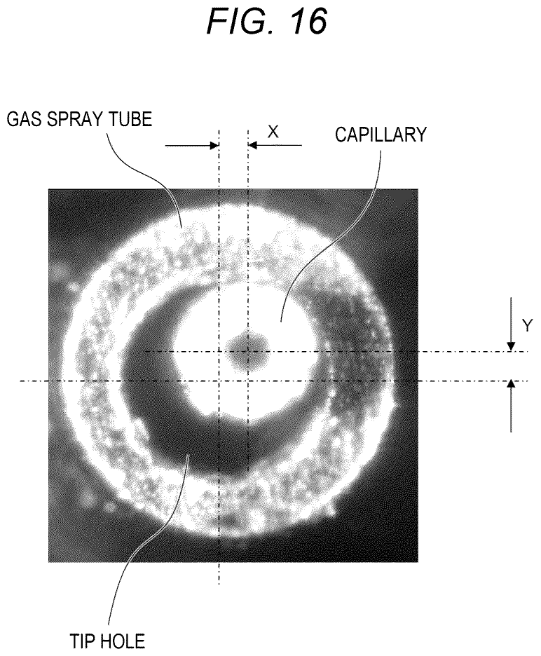

FIG. 16 is a photograph of a capillary inserted into a gas spray tube taken from the downstream side. As illustrated in FIG. 16, the center of the capillary is shifted from the central axis of a tip hole of the gas spray tube.

Next, extraction and insertion of the capillary were repeated ten times for each of the gas spray tube 28 of Example and the gas spray tube 128 of Comparative Example, and each time, the photograph was taken from the downstream side. From the captured photograph, XY coordinates of the center of the capillary 11 were obtained with the center of the tip hole 29 in the gas spray tubes 28 and 128 as the origin.

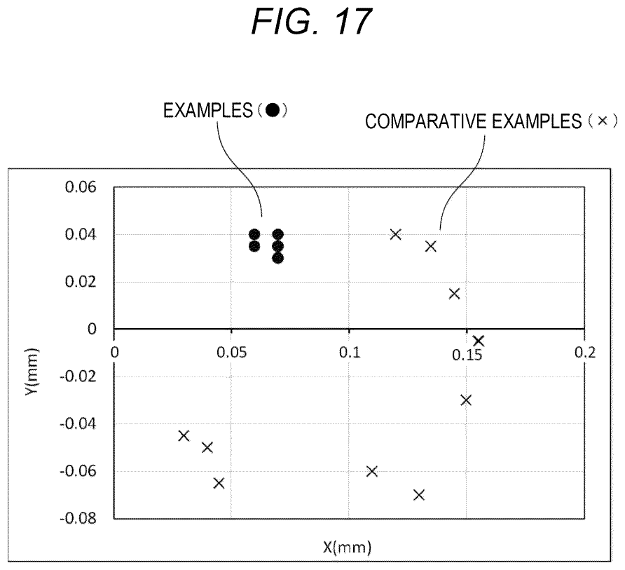

FIG. 17 is a graph obtained by plotting the XY coordinates of the centers of the capillaries 11 in Example and Comparative Example. As illustrated in FIG. 17, it can be seen that the coordinates of the centers of the capillaries 11 have a wide distribution (large variation) in Comparative Example. This is because the reproducibility of replacement of the capillary 11 is low in the configuration of Comparative Example including no deflection site because the downstream end 12 of the capillary 11 is in a free state. On the other hand, the coordinates of the centers of the capillaries 11 have a narrow distribution (small variation) in Example. This is because the capillary 11 is locked by the two points of the contact point 40 with the deflection site 334 and the contact point 41 of the tip hole 29 in the configuration of Example including the deflection site 334. In this manner, it can be seen that the gas spray tube according to Example has high reproducibility of the position of the capillary 11 by the replacement of the capillary 11.

### Analysis with Mass Spectrometer

Next, an ion source using the gas spray tube 128 according to Comparative Example and an ion source using the gas spray tube 28 according to Example were produced, and ions generated in each of the ion sources were analyzed with a mass spectrometer. Testosterone was used as a sample. The dependence of a high voltage applied to the capillary 11 was measured each time the capillary 11 was replaced eight times.

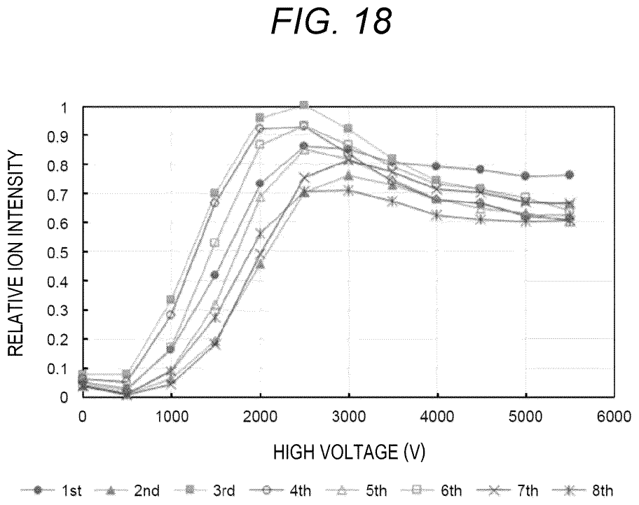

FIG. 18 is a graph illustrating a relationship between a high voltage applied to the capillary 11 and relative ion intensity in Comparative Example. Since the reproducibility of the position of the capillary is low in Comparative Example, a variation in analysis results is also large as illustrated in FIG. 18.

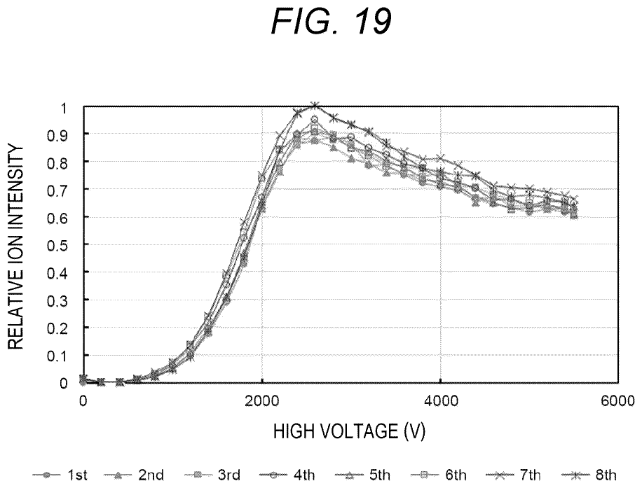

FIG. 19 is a graph illustrating a relationship between a high voltage applied to the capillary 11 and relative ion intensity in Example. Since the capillary 11 is locked by the two points of the contact point 40 with the deflection site 334 and the contact point 41 of the tip hole 29 in Example, and the reproducibility of the position by the replacement is high, it can be seen that the reproducibility in analysis results is improved as illustrated in FIG. 19.

### Regarding Channel Width

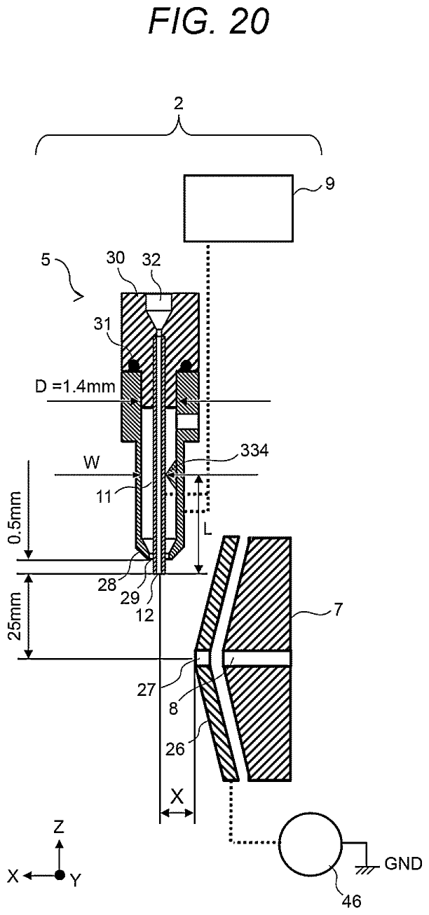

FIG. 20 is a cross-sectional view illustrating a part of a mass spectrometer used in an experiment for evaluating the dependence of a channel width (dependence of a radial size of the deflection site). Note that the gas spray tube 28 is illustrated to have the single tube in FIG. 20 for simplification of the illustration, but in practice, the gas spray tube 28 having double tubes as illustrated in FIG. 6 was used. In this experiment, an inner diameter D of a cylindrical portion of the gas spray tube 28 was set to 1.4 mm. A distance from the central axis of the hole 27 of the counter electrode 26 in the X direction to the tip of the capillary 11 was set to 25 mm, and a protruding amount of the capillary 11 from the tip of the gas spray tube 28 was set to 0.5 mm. An ammeter 46 was connected to the counter electrode 26.

In this experiment, the capillary 11 was replaced eight times, and each time, a discharge current with the counter electrode 26 when a voltage was applied to the capillary 11 was measured by the ammeter 46. From measurement results of the ammeter 46, a CV value (standard deviation average value×100) of a current variation at each voltage was obtained. A large CV value of the current indicates that the reproducibility of the position of the capillary 11 is low.

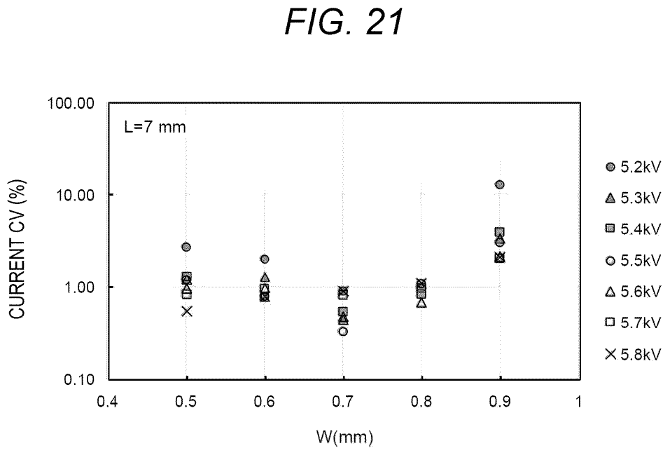

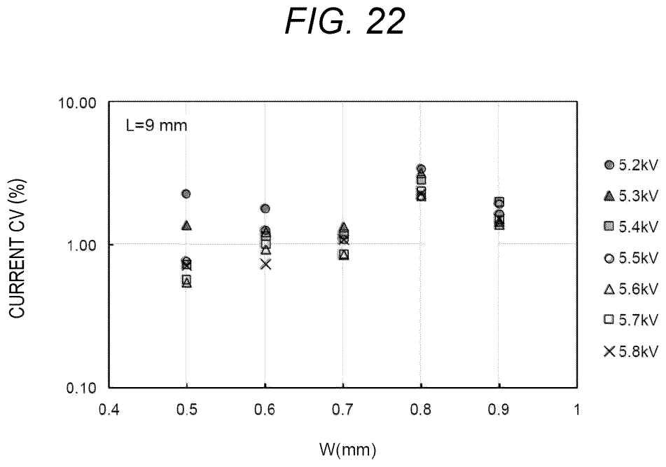

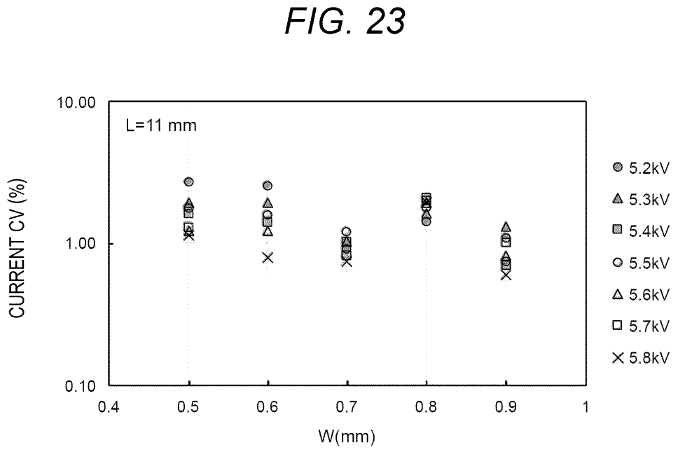

Current measurement conditions in this experiment are as follows. The voltage applied to the capillary 11 was changed each by 0.1 kV between 5.2 kV and 5.8 kV. A distance L from the tip of the gas spray tube 28 to the deflection site 334 was set to 7 mm, 9 mm, and 11 mm. A channel width W of the deflection site 334 was changed each by 1 mm between 0.5 to 0.9 mm. The obtained CV values are illustrated in FIG. 21 (L=7 mm), FIG. 22 (L=9 mm), and FIG. 23 (L=11 mm).

FIG. 21 is a graph obtained by plotting CV values of the current under the condition that the distance L from the tip of the gas spray tube 28 to the deflection site 334 is 7 mm. As illustrated in FIG. 21, it can be seen that the CV value tends to be the smallest in the case of W=0.7 mm when the distance L is 7 mm.

FIG. 22 is a graph obtained by plotting CV values of the current under the condition that the distance L from the tip of the gas spray tube 28 to the deflection site 334 is 9 mm. As illustrated in FIG. 22, it can be seen that the CV value tends to decrease in the case of W=0.5 to 0.7 mm when the distance L is 9 mm.

FIG. 23 is a graph obtained by plotting CV values of the current under the condition that the distance L from the tip of the gas spray tube 28 to the deflection site 334 is 11 mm. As illustrated in FIG. 23, it can be seen that the CV value tends to decrease in the case of W=0.7 mm when the distance L is 11 mm.

From the above, it can be found that the variation in the current sometimes increases regardless of whether the channel width W is wide or narrow, and the variation in the current tends to decrease in the vicinity of W=0.7 mm. Since the inner diameter on the upstream side of the gas spray tube 28 is D=1.4 mm, it can be said that the variation in the current decreases when the deflection site 334 protrudes to the vicinity of the central axis of the gas spray tube. Since the variation in the current is caused by a variation in a position of the tip of the capillary, it can be found that the variation in the position of the tip of the capillary decreases when the deflection site 334 protrudes to the vicinity of the central axis of the gas spray tube.

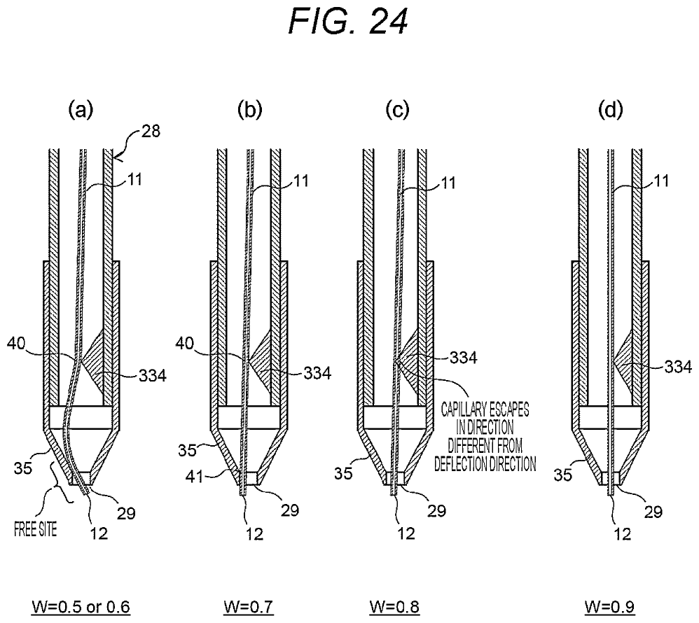

FIGS. 24(a) to 24(d) are views for describing causes of variations in the position of the capillary 11 depending on the channel width W. FIG. 24(a) illustrates a state after insertion of the capillary 11 when the channel width W=0.5 mm or W=0.6 mm. Under the condition that the channel width W=0.5 mm or W=0.6 mm (that is, a condition that a radial dimension of the deflection site 334 is smaller than a radius D/2 of the gas spray tube 28), the capillary 11 comes into contact with the guide portion 35 on the upstream side of the contact point 41 of the tip hole 29 (site having the constant inner diameter). As a result, the direction of the capillary 11 is greatly deviated, a free length (length not in contact with the gas spray tube 28) of the capillary 11 becomes long, and the variation in the position of the downstream end 12 becomes large.

FIG. 24(b) illustrates a state after insertion of the capillary 11 when the channel width W=0.7 mm. As illustrated in FIG. 24(b), under the condition that the optimum channel width W=0.7 mm (that is, a condition that the radial dimension of the deflection site 334 is equal to the radius D/2 of the gas spray tube 28), the capillary 11 is locked by the two points of the contact point 40 with the deflection site 334 and the contact point 41 with the tip hole 29, and thus, the position of the capillary 11 is firmly determined.

FIG. 24(c) illustrates a state after insertion of the capillary 11 when the channel width W=0.8 mm. As illustrated in FIG. 24(c), under the condition that the channel width W=0.8 mm (that is, a condition that the radial dimension of the deflection site 334 is larger than the radius D/2 of the gas spray tube 28), the capillary 11 escapes to the back side of the deflection site 334 (in a direction different from the deflection direction) not to come into contact with the tip hole 29 in some cases, and thus, the variation in the position of the downstream end 12 becomes large.

FIG. 24(d) illustrates a state after insertion of the capillary 11 when the channel width W=0.9 mm. As illustrated in FIG. 24(d), the capillary 11 does not come into contact with the tip hole 29 in some cases even under the condition that the channel width W=0.9 mm (that is, the condition that the radial dimension of the deflection site 334 is larger than the radius D/2 of the gas spray tube 28), and thus, the variation in the position of the downstream end 12 becomes large. It was found that the magnitude of the variation was reversed between the channel width W=0.8 mm and the channel width W=0.9 mm. A reason of this phenomenon is that the capillary 11 does not escape to the back side of the deflection site 334 when the channel width W=0.9 mm.

From the above experimental results, it is possible to increase the reproducibility of the position of the downstream end 12 of the capillary 11 when the deflection site 334 protrudes up to the vicinity of the central axis of the tip hole 29. Note that the experimental examples using the ion source 2 having the deflection site 334 of the fourth embodiment have been described, but it is apparent that the above experimental results are similar even if the deflection sites of the other embodiments are used.

### Modifications

The present disclosure is not limited to the above-described embodiments and includes various modifications. For example, the above-described embodiments have been described in detail in order to describe the present disclosure in an easily understandable manner, and do not necessarily include the entire configuration that has been described above. Further, a part of a certain embodiment can be replaced with the configuration of another embodiment. Further, the configuration of one embodiment can be also added with the configuration of another embodiment. Further, a part of the configuration of each of the embodiments may be deleted or added or replaced with a part of the configuration of another embodiment.

### REFERENCE SIGNS LIST

1 mass spectrometer
2 ion source
3 mass spectrometry unit
4 vacuum container
5 ion generator
6 ion source chamber
7 introduction electrode
8 hole
9 power supply
10 control device
11 capillary
12 downstream end
13 exhaust port
14 window
15 to 17 vacuum chamber
18 to 19 hole
20 to 22 vacuum pump
23 ion transport unit
24 ion analyzer
25 detector
26 counter electrode
27 hole
28, 128 gas spray tube
29 tip hole
30 connector
31 sealing member
32 connection portion
33 deflection site
35 guide portion
36 first tube
37 second tube
38 fitting portion
39 cylindrical portion
40 contact point
41 contact point
43 opening
46 ammeter
49 space

1. An ion source comprising:
a capillary; and
a gas spray tube into which the capillary is inserted, the gas spray tube spraying a gas to an outer side of the capillary,
wherein the gas spray tube has a deflection site on an upstream side of a tip hole of the gas spray tube, the deflection site deflecting a downstream end of the capillary with respect to a central axis of the tip hole of the gas spray tube.

2. The ion source according to claim 1, wherein the gas spray tube has a guide portion that is disposed between the deflection site and the tip hole and has an inner diameter decreasing toward a downstream side.

3. The ion source according to claim 2, wherein a cross-sectional shape of the guide portion is a tapered shape.

4. The ion source according to claim 1, wherein the deflection site protrudes to at least a position of the central axis of the tip hole.

5. The ion source according to claim 1, wherein the tip hole includes a plurality of portions having different inner diameters, and a downstream portion out of the plurality of portions has a larger inner diameter.

6. The ion source according to claim 1, wherein a plurality of the deflection sites are provided at different positions in a longitudinal direction of the gas spray tube and at different phases.

7. The ion source according to claim 1, wherein
the gas spray tube includes at least two tubes of a first tube on the upstream side and a second tube on a downstream side, the second tube being disposed on an outer side of the first tube, and
the deflection site is provided in the first tube, and deflects the downstream end of the capillary with respect to a central axis of a tip hole of the second tube.

8. The ion source according to claim 7, wherein the second tube has a guide portion that is disposed between the deflection site and the tip hole of the second tube and has an inner diameter decreasing toward the downstream side.

9. The ion source according to claim 7, wherein a space is provided between an outer wall surface of the first tube and an inner wall surface of the second tube.

10. The ion source according to claim 7, wherein the deflection site has a bent structure provided at a tip portion of the first tube.

11. The ion source according to claim 1, wherein the deflection site is a plate-shaped member.

12. The ion source according to claim 1, wherein the deflection site is a protrusion protruding radially inward of the gas spray tube.

13. A mass spectrometer comprising the ion source according to claim 1.

14. The mass spectrometer according to claim 13, wherein the deflection site is disposed to make the downstream end of the capillary directed to an extension line of an inlet of the mass spectrometer.

15. A capillary insertion method for inserting a capillary into a gas spray tube, the method comprising:
bringing the capillary into contact with a deflection site; and
bringing the capillary into contact with a tip hole of the gas spray tube,
wherein the gas spray tube is configured to be capable of spraying a gas to an outer side of the capillary, and
the deflection site, which deflects a downstream end of the capillary with respect to a central axis of the tip hole of the gas spray tube, is provided at an upstream side of the tip hole of the gas spray tube.
